(19) United States
(12) Patent Application Publication
(10) Pub. No.: US 2026/0184132 A1
(43) Pub. Date: Jul. 2, 2026

(54) STABILIZER ASSEMBLY WITH SERIES ELASTIC ACTUATOR

(71) Applicant: HYUNDAI WIA Corporation, Changwon-si, Gyeongsangnam-do (KR)

(72) Inventor: Seon Dong KIM, Uiwang-si (KR)

(73) Assignee: HYUNDAI WIA Corporation, Changwon-si, Gyeongsangnam-do (KR)

(21) Appl. No.: 19/428,707

(22) Filed: Dec. 22, 2025

(30) Foreign Application Priority Data
Dec. 30, 2024 (KR) 1020240199739

(51) Int. Cl. B60G 21/05

(52) U.S. Cl. CPC B60G 21/05; B60G 2202/42; B60G 2204/8302; B60G 2400/95; B60G 2401/17

(57) ABSTRACT

Disclosed is a stabilizer assembly with a series elastic actuator, the stabilizer assembly including a first stabilizer bar connected to one side wheel, a second stabilizer bar connected to the other side wheel, and an actuator disposed between the first and second stabilizer bars, the actuator being configured to transmit rotational force between the first and second stabilizer bars, wherein the actuator includes a housing and a motor, a multi-stage gear, and a series elastic body disposed in the housing.

### CROSS-REFERENCE TO THE RELATED APPLICATION

The present application claims priority to and the benefit of Korean Patent Application No. 10-2024-0199739, filed on Dec. 30, 2024, in the Korean Intellectual Property Office, the entire disclosure of which is incorporated herein by reference.

### BACKGROUND

### 1. Field

The present disclosure relates to a stabilizer assembly with a series elastic actuator, and more particularly to a stabilizer assembly with a new structure in which a series elastic actuator is adopted as an actuator constituting the stabilizer assembly, enabling the elimination of a decoupler and a torque sensor.

### 2. Description of the Related Art

Generally, when a vehicle traverses uneven road surfaces or corners at high speed, centrifugal force causes a vehicle body to tilt, resulting in different heights on the left and right sides. Stabilizers are used to reduce such rolling and thus to enhance vehicle body stability.

A mechanical stabilizer bar, which is a type of stabilizer, connects left and right wheels to each other, counteracting increased body tilt to enhance steering stability.

An active roll stabilizer, in which a stabilizer bar is divided into two parts, an actuator is disposed therebetween, and the actuator is electronically controlled to actively control the movement of the stabilizer, is also used.

Generally, the actuator of an active roll stabilizer includes a motor that generates rotational force to produce torque between the two stabilizer bars and a gear that transmits the rotational force of the motor to the output-side stabilizer bar. Furthermore, a torque sensor is adopted to detect the torque acting between the two stabilizer bars, and a decoupler that protects a system from impact is included. For reference, the decoupler decouples the two torsion bars during driving on uneven surfaces, such as off-road, to protect the system from road impact.

However, torque sensors inherently suffer from reduced measurement precision as the measured torque increases, are vulnerable to external impact, and are costly. Furthermore, the size and weight of the decoupler cause an increase in the weight of the actuator.

### SUMMARY

The present disclosure has been made in view of the above problems, and an aspect of the present disclosure is to provide a stabilizer assembly with a new structure in which a series elastic actuator (SEA) is adopted as an actuator of stabilizer assembly, whereby it is possible to eliminate a torque sensor and a decoupler from a conventional structure and to perform the functions thereof through the series elastic actuator.

A stabilizer assembly with a series elastic actuator according to a first embodiment of the present disclosure to achieve the above aspect includes a first stabilizer bar connected to one side wheel, a second stabilizer bar connected to the other side wheel, and an actuator disposed between the first and second stabilizer bars, the actuator being configured to transmit rotational force between the first and second stabilizer bars, wherein the actuator includes a housing and a motor, a multi-stage gear, and a series elastic body disposed in the housing.

An end of the first stabilizer bar may be fixedly installed to one end of the actuator while an end of the second stabilizer bar may be rotatably installed to the other end of the actuator, the motor and the multi-stage gear may be sequentially disposed in a direction from the one end to the other end of the actuator, the multi-stage gear may include a first planetary gear, a second planetary gear, and a third planetary gear sequentially disposed in an axial direction toward the other end of the actuator, and each planetary gear may include a sun gear and a plurality of pinion gears disposed around the sun gear, the pinion gears being gear engaged with gear teeth formed on an inner circumferential surface of the housing.

The first planetary gear may be operated by driving of the motor, a driving shaft of the motor may protrude to the other side to form the sun gear of the first planetary gear, the plurality of pinion gears may be rotatably or revolvably disposed about the sun gear of the first planetary gear, and a first carrier may be rotatably connected to the pinion gears of the first planetary gear. The second planetary gear may be operated by rotation of the first carrier, a carrier shaft of the first carrier may protrude to the other side to form the sun gear of the second planetary gear, a plurality of pinion gears may be rotatably or revolvably disposed about the sun gear of the second planetary gear, and a second carrier may be rotatably connected to the pinion gears of the second planetary gear.

The series elastic body may be configured such that a plurality of elastic plates is arranged side by side in an axial direction and adjacent ones of the elastic plates are positionally constrained by a pin.

The series elastic body may be a spring type series elastic body in which a coil extends in the axial direction to provide axial elasticity or a cage type series elastic body in which a plurality of rods extends in the axial direction while being spaced apart from each other along an outer circumference thereof.

The series elastic body may be disposed between the second planetary gear and the third planetary gear.

One side of the series elastic body may be fixedly coupled to the second carrier to receive rotational force of the second carrier, a driving carrier may be fixedly installed on the other side of the series elastic body, a carrier shaft of the driving carrier may protrude to the other side to form the sun gear of the third planetary gear, a plurality of pinion gears may be rotatably or revolvably disposed about the sun gear of the third planetary gear, a third carrier may be rotatably connected to the pinion gears of the third planetary gear, the third carrier may be mounted on the inner circumferential surface of the housing via a bearing member, and the end of the second stabilizer bar may be coupled to the other side of the third carrier.

The series elastic body may be disposed between the third planetary gear and the other end of the actuator.

The third planetary gear may be operated by rotation of the second carrier, a carrier shaft of the second carrier may protrude to the other side to form the sun gear of the third planetary gear, a plurality of pinion gears may be rotatably or revolvably disposed about the sun gear of the third planetary gear, a third carrier may be rotatably connected to the pinion gears of the third planetary gear, one side of the series elastic body may be fixedly coupled to the third carrier to receive rotational force of the third carrier, a driving carrier may be fixedly installed on the other side of the series elastic body, the driving carrier may be mounted on the inner circumferential surface of the housing via a bearing member, and the end of the second stabilizer bar may be coupled to the other side of the driving carrier.

A barrier block may be press-fitted and fixed between the motor and one end of the actuator, the first stabilizer bar may be fixed to the barrier block, and a face spline may be provided on each of facing sections of the first stabilizer bar and the barrier block such that the first stabilizer bar and the barrier block are spline coupled to each other.

A face spline may be provided on each of facing sections of the third carrier and the second stabilizer bar such that the third carrier and the second stabilizer bar are spline coupled to each other.

A face spline may be provided on each of facing sections of the driving carrier and the second stabilizer bar such that the driving carrier and the second stabilizer bar are spline coupled to each other.

The stabilizer assembly may include a magnetic encoder, wherein the magnetic encoder may be configured such that a magnetic plate with alternating polarities is disposed on the outer surface of the series elastic body, a printed circuit board having at least one magnetic sensor mounted thereon is mounted on the inner circumferential surface of the housing, the magnetic sensor is spaced apart from the magnetic plate by a predetermined distance, and a change in a magnetic field generated by rotation of the magnetic plate together with the series elastic body is detected by the magnetic sensor, thereby detecting rotational displacement of the series elastic body.

### BRIEF DESCRIPTION OF THE DRAWINGS

The accompanying drawings, which are incorporated in this specification, illustrate exemplary embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a conceptual view of a stabilizer assembly according to a first embodiment of the present disclosure;

FIG. 2 is a schematic sectional view showing the internal structure of the stabilizer assembly according to the first embodiment of the present disclosure;

FIG. 3 is a detailed sectional view showing the internal structure of the stabilizer assembly according to the first embodiment of the present disclosure;

FIG. 4 is a perspective view of a series elastic body provided in the stabilizer assembly according to the first embodiment of the present disclosure when viewed from various angles;

FIG. 5 is a conceptual view of a stabilizer assembly according to a second embodiment of the present disclosure;

FIG. 6 is a schematic sectional view showing the internal structure of the stabilizer assembly according to the second embodiment of the present disclosure; and

FIG. 7 is a conceptual view showing the configuration of a magnetic encoder in the first and second embodiments.

### DETAILED DESCRIPTION OF EXEMPLARY EMBODIMENTS

Hereinafter, exemplary embodiments of the present disclosure will be described in detail with reference to the accompanying drawings. Embodiments of the present disclosure are provided to more fully illustrate the present disclosure to a person having ordinary skill in the art, the following embodiments may be modified in various other forms, and the scope of the present disclosure is not limited to the following embodiments. The embodiments are provided to make the present disclosure more faithful and complete and to completely convey the idea of the present disclosure to those skilled in the art.

In the following drawings, the thickness or size of each layer is exaggerated for convenience and clarity of description and the same reference symbols in the drawings refer to the same elements. As used herein, the term “and/or” includes any one of the enumerated items and any combination of one or more thereof. In addition, as used herein, the term “connected” refers not only to direct connection between members A and B but also to indirect connection between members A and B with member C interposed between members A and B. The terms used in the specification are intended to describe specific embodiments and are not intended to limit the present disclosure. As used herein, singular forms may include plural forms, unless the context clearly indicates otherwise. In addition, as used herein, the terms “include” (or “include”) and/or “comprising” (or “including”) are intended to specify the presence of stated figures, numbers, steps, operations, members, elements, and/or groups thereof and do not exclude the presence or addition of one or more other figures, numbers, steps, operations, members, elements, and/or groups.

While terms such as first and second are used herein to describe various members, parts, regions, layers, and/or portions, the members, the parts, the regions, the layers, and/or the portions are not to be limited by the terms. The terms are used only to distinguish one member, one part, one region, one layer, or one portion from another member, another part, another region, another layer, or another portion. Thus, a first member, a first part, a first region, a first layer, or a first portion hereinafter described may refer to a second member, a second part, a second region, a second layer, or a second portion without departing from the teachings of the disclosure.

Terms related to space, such as “beneath”, “below”, “lower”, “above”, and “upper”, may be utilized to facilitate understanding of one element or feature shown in the drawings as different from another element or feature. The terms related to space are intended to facilitate understanding of the present disclosure in various states of process or use and are not intended to limit the present disclosure. For example, if an element or feature in a FIG. is inverted, an element or feature described as “beneath” or “below” becomes “above” or “upper”. Thus, “beneath” is a concept that encompasses “above” or “below”.

### First Embodiment

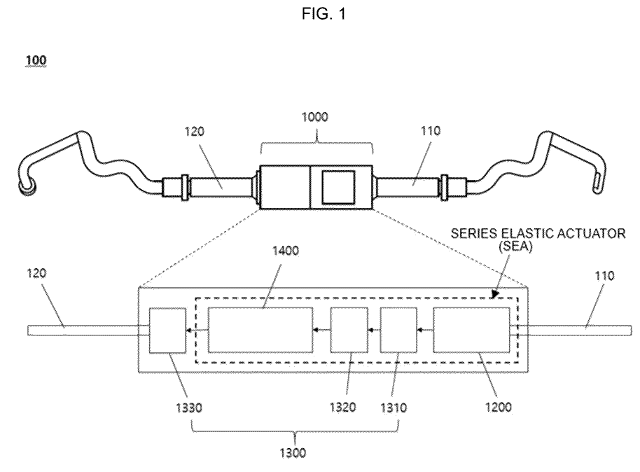

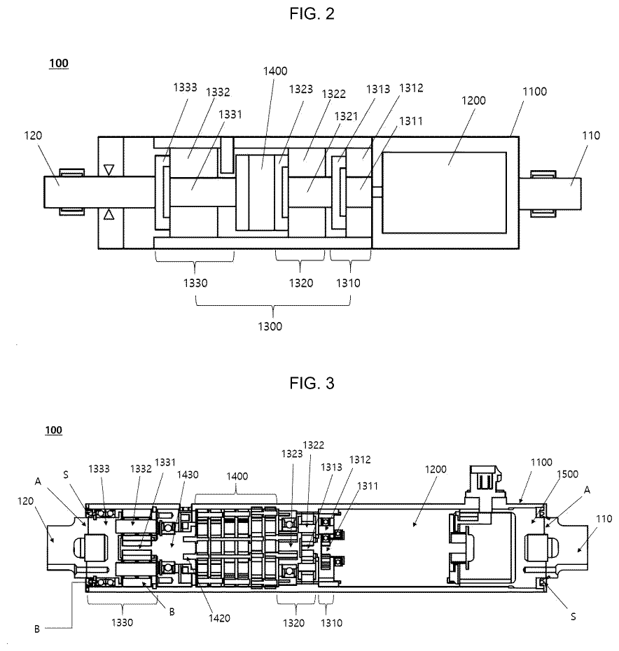

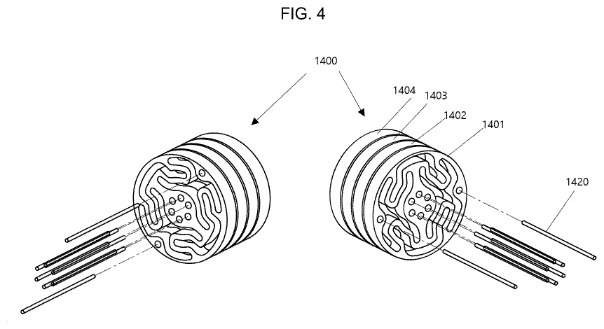

FIG. 1 is a conceptual view of a stabilizer assembly according to a first embodiment of the present disclosure, FIG. 2 is a schematic sectional view showing the internal structure of the stabilizer assembly according to the first embodiment of the present disclosure, FIG. 3 is a detailed sectional view showing the internal structure of the stabilizer assembly according to the first embodiment of the present disclosure, and FIG. 4 is a perspective view of a series elastic body provided in the stabilizer assembly according to the first embodiment of the present disclosure when viewed from various angles. Hereinafter, a stabilizer assembly with a series elastic actuator according to a first embodiment of the present disclosure will be described with reference to the figures.

The stabilizer assembly 100 according to the first embodiment of the present disclosure may include a first stabilizer bar 110 connected to one side wheel, a second stabilizer bar 120 connected to the other side wheel, and an actuator 1000 disposed between the first and second stabilizer bars 110 and 120 to transmit rotational force therebetween.

The first and second stabilizer bars 110 and 120 may perform the function of controlling the roll behavior of a vehicle during vehicle operation. One end of the first stabilizer bar 110 may be installed on one side wheel, and the other end of the first stabilizer bar 110 may be connected to the actuator 1000. The first stabilizer bar 110 may be a fixed type stabilizer bar, the end of which may be fixedly installed on one end (input end) of the actuator 1000. One end of the second stabilizer bar 120 may be installed on the other side wheel, and the other end of the second stabilizer bar 120 may be connected to the actuator 1000. The second stabilizer bar 120 may be a rotary type stabilizer bar, the end of which may be rotatably installed on the other end (output end) of the actuator 1000. The first and second stabilizer bars 110 and 120 may be coupled to both ends of the actuator 1000 on the same axis as a driving shaft of a motor 1200 of the actuator 1000, and the first stabilizer bar 110 and the second stabilizer bar 120 may receive rotational force of the actuator 1000.

The actuator 1000 may control the torsional moment of the two stabilizer bars. According to the first embodiment of the present disclosure, the actuator 1000 may include a housing 1100 and a motor 1200, a multi-stage gear 1300, and a series elastic body 1400 disposed in the housing 1100.

First, the housing 1100 may be provided as a hollow cylindrical member, and may receive the motor 1200, the gear 1300, the series elastic body 1400, and another component 1500 in an inner space thereof. These components may be disposed adjacent to each other in an axial direction of the housing 1100. In the present disclosure, the side where the fixed type first stabilizer bar 110 is disposed may be referred to as one end of the housing 1100, and the side where the rotary type second stabilizer bar 120 is disposed may be referred to as the other end of the housing 1100. A part of an inner circumferential surface of the housing 1100, i.e., the inner circumferential surface of the housing 1100 corresponding to the position of the multi-stage gear 1300, may be provided with gear teeth (not shown) formed in a longitudinal direction thereof, and the inner circumferential surface of the housing 1100 may perform the function of a ring gear.

The motor 1200 and the multi-stage gear 1300 may be sequentially disposed in the housing 1100 in a direction from one end (input end) to the other end (output end) of the actuator 1000. The motor 1200 may be fixedly disposed in the housing 1100. Specifically, the motor 1200 may be configured such that a rotor and a stator are provided in a motor housing, wherein the motor housing may be press-fitted into the housing 1100 of the actuator 1000 and fixedly installed in the housing 1100. In the motor 1200, a driving shaft of the rotor may be rotated according to a control command from a controller. The driving shaft of the rotor may protrude from the motor housing toward an axial outside, i.e., the other side. The protruding part of the driving shaft may extent through the center of a first planetary gear 1310 so as to form a sun gear 1311 of the first planetary gear, a description of which will follow.

The multi-stage gear 1300 may include a first planetary gear 1310, a second planetary gear 1320, and a third planetary gear 1330, which may be sequentially disposed in an axial direction toward the other end of the actuator 1000. Each planetary gear may include a sun gear and a plurality of pinion gears disposed around the sun gear. The plurality of pinion gears may be rotated and revolved around the rotating sun gear. A carrier may be connected to the pinion gears, enabling the plurality of pinion gears to rotate as a single unit. The rotation of the pinion gears may cause the carrier to rotate. In a general planetary gear, a ring gear may be installed on the outside of the pinion gear, and the pinion gear may be engaged with the ring gear to rotate. In the present disclosure, a separate ring gear may not be provided, gear teeth may be formed on the inner circumferential surface of the housing 1100 so as to be gear engaged with the pinion gears. That is, the inner circumferential surface of the housing may perform the function of a ring gear.

More specifically, the first planetary gear 1310 may be disposed in a direction from the motor 1200 to the output end of the actuator 1000 to directly receive rotational force of the motor 1200, and the second planetary gear 1320 may be disposed in a direction from the first planetary gear 1310 to the output end of the actuator 1000 to directly receive rotational force of the first planetary gear 1310. The positions and coupling relationships of the motor 1200, the first planetary gear 1310, and the second planetary gear 1320 may be applied identically to the first embodiment and a second embodiment, a description of which will follow. The positions of the series elastic body 1400 and the third planetary gear 1330 differ depending on the embodiments, and the series elastic body 1400 and the third planetary gear 1330 will be described in detail in each embodiment.

The series elastic body 1400 may be disposed. The series elastic body 1400 may be configured such that a plurality of elastic plates is arranged side by side in an axial direction. Referring to FIG. 4, an exemplary structure in which four elastic plates 1401, 1402, 1403, and 1404 (first to fourth elastic plates) are arranged in series in the axial direction is shown. Each of the elastic plates 1401, 1402, 1403, and 1404 may have a predetermined thickness and may include a circular frame member defining an outermost shape and a geometrically shaped inner member provided in the circular frame member. The elastic plates may be identical and have the same elastic modulus. Furthermore, adjacent elastic plates are positionally constrained by a pin 1420, forming an integrated structure where all elastic plates are coupled as one.

As another structure of the series elastic body 1400, a spring type series elastic body or a cage type series elastic body may be adopted. That is, the series elastic body 1400 may be a spring type series elastic body in which a coil extends in the axial direction to provide axial elasticity or a cage type series elastic body in which a plurality of rods extends in the axial direction while being spaced apart from each other along an outer circumference thereof.

According to the first embodiment of the present disclosure, the series elastic body 1400 may be disposed between the second planetary gear 1320 and the third planetary gear 1330. The assembly according to the first embodiment is shown in FIGS. 1 to 3. Hereinafter, details thereof will be described.

As described above, the first planetary gear 1310 may be disposed in the direction from the motor 1200 to the output end of the actuator 1000 to directly receive rotational force of the motor 1200, and the second planetary gear 1320 may be disposed in the direction from the first planetary gear 1310 to the output end of the actuator 1000 to directly receive rotational force of the first planetary gear 1310. When the motor 1200 drives the driving shaft to rotate, the first planetary gear 1310 connected to the driving shaft may be operated. That is, the driving shaft of the motor 1200 may protrude to the other side to form the sun gear 1311 of the first planetary gear, the plurality of pinion gears may be rotatably and revolvably disposed about the sun gear 1311 of the first planetary gear 1311, and the first carrier 1313 may be connected to the pinion gears 1312 of the first planetary gear. The first carrier 1313 may be rotated by the rotation of the pinion gears 1312 of the first planetary gear.

The second planetary gear 1320 may be operated by the rotation of the first carrier 1313. That is, a carrier shaft of the first carrier 1313 may protrude to the other side to form a sun gear 1321 of the second planetary gear, and a plurality of pinion gears may be rotatably or revolvably disposed about the sun gear 1321 of the second planetary gear, and a second carrier 1323 may be connected to the pinion gears 1322 of the second planetary gear. The second carrier 1323 may be rotated by the rotation of the pinion gears 1322 of the second planetary gear.

One side of the series elastic body 1400 may be fixedly coupled to the second carrier 1323 to receive rotational force of the second carrier 1323. That is, the first elastic plate 1401 located closest to the input end, among the plurality of elastic plates of the series elastic body 1400, may be fixedly coupled to the second carrier 1323. The rotational force of the second carrier 1323 may be first transmitted to the first elastic plate 1401. As described above, the series elastic body 1400 of the present disclosure may form an integrated structure formed by the pins 1420. The rotational force transmitted to the first elastic plate 1401 may be directly transmitted to the last elastic plate 1440 in the axial direction. As the rotational force of the second carrier 1323 is transmitted to a sun gear 1331 of the third planetary gear through the series elastic body 1400, a difference in rotational angle may occur between the second carrier 1323 and the driving carrier 1430 due to the stiffness of the elastic body. To measure this difference, a magnetic plate 1610 may be mounted on the pinion gear 1332 of the third planetary gear.

The driving carrier 1430 may be fixedly installed on the other side of the series elastic body 1400. For example, as shown in FIG. 3, the axial position of the driving carrier 1430 may be fixed in a manner in which some pins 1420 protruding through the elastic plate are inserted into holes in the driving carrier 1430. The driving carrier 1430 may be rotated together with the series elastic body 1400 by the rotational force transmitted from the series elastic body 1400.

The third planetary gear 1330 may be operated by the rotation of the driving carrier 1430. That is, a carrier shaft of the driving carrier 1430 may protrude to the other side to form a sun gear 1331 of the third planetary gear, and a plurality of pinion gears 1332 may be rotatably or revolvably disposed about the sun gear 1331 of the third planetary gear, and a third carrier 1333 may be connected to the pinion gears 1332 of the third planetary gear. The third carrier 1333 may be rotated by the rotation of the pinion gears 1332 of the third planetary gear.

For reference, as shown in FIG. 3, the driving carrier 1430 may include a base seated on the axially last elastic plate of the series elastic body 1400, a protrusion forming the sun gear 1331 of the third planetary gear, and a cylindrical carrier body provided therebetween. The cylindrical carrier body may be rotated relative to the inner circumferential surface of the housing 1100 via a bearing member B.

According to the first embodiment of the present disclosure, an end of the third carrier 1333 of the third planetary gear may be exposed at the other end of the housing 1100. The third carrier 1333 may be rotatably mounted on the inner circumferential surface of the housing 1100 via the bearing member, and an end of the second stabilizer bar 120 may be coupled to the other side of the third carrier 1333.

For reference, the gear ratio of the third planetary gear 1330 may be 10:1 or less, and the gear ratio of each of the first planetary gear 1310 and the second planetary gear 1320 may be 20:1 or more.

According to the first embodiment of the present disclosure, ends of the actuator 1000 and the first and second stabilizer bars 110 and 120 may be face spline coupled (A) to each other.

First, the end of the first stabilizer bar 110 may be face spline coupled (A) to the input end of the actuator 1000. Referring to FIG. 3, a barrier block 1500 may be press-fitted and fixed between the motor 1200 and one end of the housing 1100. The barrier block 1500 may close the open input end of the housing 1100. The barrier block 1500 may be configured as a cylinder having the same section as the housing 1100 so as to be press-fit into the housing 1100 with an inside relieved. Furthermore, a sealing member S may be installed to seal a gap between the barrier block 1500 and the inner circumferential surface of the housing 1100 such that the barrier block 1500 can seal the inside of the housing 1100 from the outside. In this structure, the first stabilizer bar 110 may be connected to the barrier block 1500 and thus be connected to one end of the actuator 1000. At this time, a face spline may be provided on each of facing sections of the first stabilizer bar 110 and the barrier block 1500 such that the first stabilizer bar 110 and the barrier block 1500 can be spline coupled to each other. Consequently, the first stabilizer bar 110 may be spline connected to the barrier block 1500 and thus be fixedly installed on one end of the actuator 1000.

According to the first embodiment, the third carrier 1333 of the third planetary gear 1330 may be exposed at the other end of the housing 1100. Consequently, the second stabilizer bar 120 may be connected to the third carrier 1333, and thus be connected to the other end of the actuator 1000. At this time, a face spline may be provided on each of facing sections of the third carrier 1333 and the second stabilizer bar 120 such that the third carrier 1333 and the second stabilizer bar 120 can be spline coupled to each other. Consequently, the second stabilizer bar 120 may be spline connected to the third carrier 1333 and thus be rotatably installed on the other end of the actuator 1000.

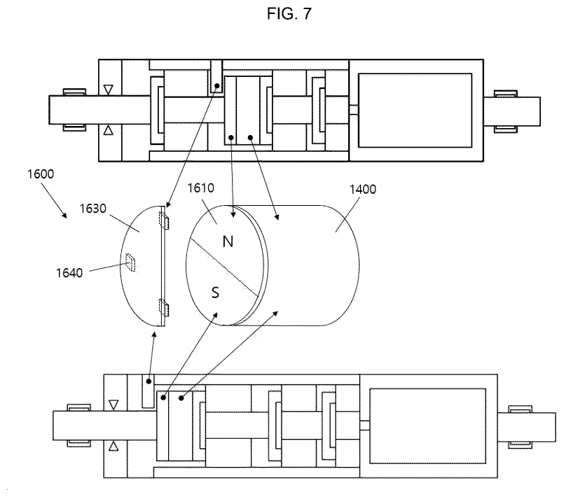

In the first embodiment of the present disclosure, a rotary encoder configured to detect the rotational displacement of the series elastic body 1400 may be provided. Preferably, a non-contact magnetic encoder 1600 is adopted as the rotary encoder. Referring to FIG. 7, the magnetic encoder 1600 may include a magnetic plate 1610 configured to induce changes in a magnetic field upon rotation and a printed circuit board 1630 provided with a magnetic sensor 1640 configured to detect the changes. The magnetic plate 1610 may be attached to the series elastic body 1400, and the printed circuit board 1630 may be mounted on the inner circumferential surface of the housing 1100 between the series elastic body 1400 and the third planetary gear.

The magnetic plate 1610 may have polarities divided such that an N pole and an S pole are alternately disposed at least once, and may be bonded and fixed to the other surface of the series elastic body 1400 so as to be rotated together with the series elastic body 1400. At least one magnetic sensor 1640 may be mounted on the printed circuit board 1630. The printed circuit board 1630 may be mounted on the inner circumferential surface of the housing 1100 at the position between the series elastic body 1400 and the third planetary gear, the printed circuit board 1630 may be positioned such that the printed circuit board 1630 and the magnetic plate 1610 face each other in a non-contact state. Consequently, the magnetic sensor 1640 may be disposed spaced apart from the magnetic plate 1610 by a predetermined distance. As the magnetic plate 1610 is rotated together with the series elastic body 1400, changes in the magnetic field may occur, and the magnetic sensor 1640 may detect these changes in the magnetic field. In this manner, the rotational displacement of the series elastic body 1400 may be detected by the magnetic sensor 1640.

### Second Embodiment

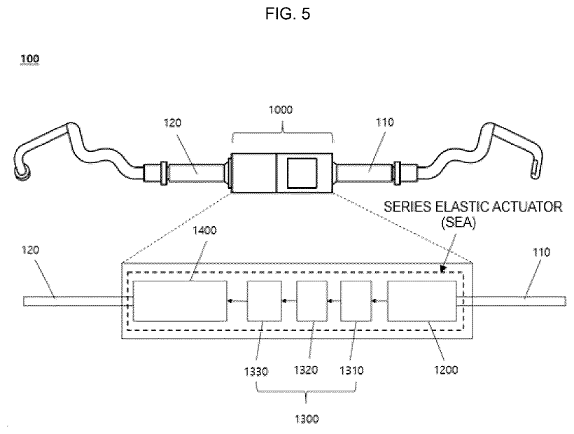

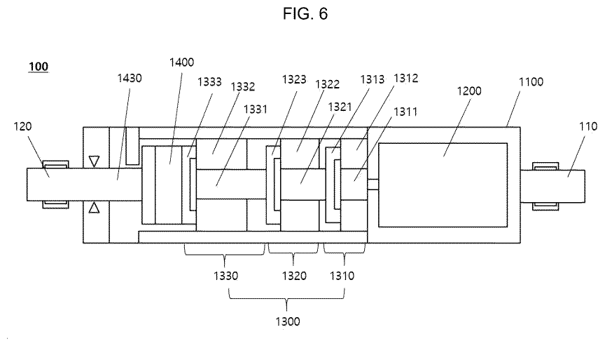

FIG. 5 is a conceptual view of a stabilizer assembly according to a second embodiment of the present disclosure, and FIG. 6 is a schematic sectional view showing the internal structure of the stabilizer assembly according to the second embodiment of the present disclosure. Hereinafter, a stabilizer assembly 100 with a series elastic actuator according to a second embodiment of the present disclosure will be described with reference to the figures.

As shown in the figures, the stabilizer assembly 100 according to the second embodiment of the present disclosure may include a first stabilizer bar 110, a second stabilizer bar 120, and an actuator 1000 disposed between the first and second stabilizer bars 110 and 120 to transmit rotational force therebetween. The internal structure of the actuator 1000 of the second embodiment is identical to the internal structure of the actuator of the first embodiment, except for the positions of the series elastic body 1400 and the third planetary gear 1330, and therefore a repeated description of the same configuration will be omitted.

According to the second embodiment of the present disclosure, the second planetary gear 1320 and the third planetary gear 1330 may be sequentially disposed, and the series elastic body 1400 may be disposed at the output end of the third planetary gear 1330.

In the same manner as in the first embodiment, the first planetary gear 1310 may be disposed in the direction from the motor 1200 to the output end of the actuator 1000 to directly receive rotational force of the motor 1200, and the second planetary gear 1320 may be disposed in the direction from the first planetary gear 1310 to the output end of the actuator 1000 to directly receive rotational force of the first planetary gear 1310. According to the second embodiment of the present disclosure, the third planetary gear 1330 may be disposed in the direction from the second planetary gear 1320 to the output end of the actuator 1000 to directly receive rotational force of the second planetary gear 1320.

The second carrier 1323 may be rotated by rotation of the second planetary gear 1320, and the third planetary gear 1330 may be operated by rotation of the second carrier 1323. That is, the carrier shaft of the second carrier 1323 may protrude to the other side to form the sun gear 1331 of the third planetary gear, the plurality of pinion gears may be rotatably and revolvably disposed about the sun gear 1331 of the third planetary gear, and the third carrier 1333 may be connected to the pinion gears 1332 of the third planetary gear. The third carrier 1333 may be rotated by the rotation of the pinion gears 1332 of the third planetary gear.

One side of the series elastic body 1400 may be fixedly coupled to the third carrier 1333 to receive rotational force of the third carrier 1333.

That is, the first elastic plate 1401 located closest to the input end, among the plurality of elastic plates of the series elastic body 1400, may be fixedly coupled to the third carrier 1333. The rotational force of the third carrier 1333 may be first transmitted to the first elastic plate 1401. As described above, the series elastic body 1400 of the present disclosure may form an integrated structure formed using the pins 1420. The rotational force transmitted to the first elastic plate 1401 may be directly transmitted to the last elastic plate in the axial direction, and some of the rotational force may be offset through the series elastic body 1400.

The driving carrier 1430 may be fixedly installed on the other side of the series elastic body 1400. For example, the axial position of the driving carrier 1430 may be fixed in a manner in which some pins 1420 protruding through the elastic plate are inserted into holes in the driving carrier 1430. The driving carrier 1430 may be rotated together with the series elastic body 1400 by the rotational force transmitted from the series elastic body. For reference, the driving carrier 1430 may be rotated relative to the inner circumferential surface of the housing 1100 via the bearing member B.

According to the second embodiment of the present disclosure, the end of the driving carrier 1430 of the series elastic body 1400 may be exposed at the other end of the housing 1100. The end of the second stabilizer bar 120 may be coupled to the other side of the driving carrier 1430.

According to the second embodiment of the present disclosure, the ends of the actuator 1000 and the first and second stabilizer bars 110 and 120 may be face spline coupled (A) to each other.

First, the end of the first stabilizer bar 110 may be face spline coupled (A) to the input end of the actuator 1000. In the second embodiment, the barrier block 1500 may be installed on one end of the housing 1100 to close the open input end of the housing 1100, and the first stabilizer bar 110 may be connected to the barrier block 1500. At this time, a face spline may be provided on each of facing sections of the first stabilizer bar 110 and the barrier block 1500 such that the first stabilizer bar 110 and the barrier block 1500 can be spline coupled to each other. Consequently, the first stabilizer bar 110 may be spline connected to the barrier block 1500 and thus be fixedly installed on one end of the actuator 1000.

According to the second embodiment, the driving carrier 1430 may be exposed at the other end of the housing 1100. Consequently, the second stabilizer bar 120 may be connected to the driving carrier 1430 and thus be connected to the other end of the actuator 1000. At this time, a face spline may be provided on each of facing sections of the driving carrier 1430 and the second stabilizer bar 120 such that the driving carrier 1430 and the second stabilizer bar 120 can be spline coupled to each other. Consequently, the second stabilizer bar 120 may be spline connected to the driving carrier 1430 and thus be rotatably installed on the other end of the actuator 1000.

In the second embodiment of the present disclosure, a rotary encoder configured to detect the rotational displacement of the series elastic body 1400 may be provided. Preferably, a non-contact magnetic encoder 1600 is adopted as the rotary encoder. Referring to FIG. 7, the magnetic encoder 1600 may include a magnetic plate 1610 configured to induce changes in a magnetic field upon rotation and a printed circuit board 1630 provided with a magnetic sensor 1640 configured to detect the changes. The magnetic plate 1610 may be attached to the series elastic body 1400, and the printed circuit board 1630 may be mounted on the inner circumferential surface of the housing 1100 at the other side of the series elastic body 1400.

The magnetic plate 1610 may have polarities divided such that an N pole and an S pole are alternately disposed at least once, and may be bonded and fixed to the other surface of the series elastic body 1400 so as to be rotated together with the series elastic body 1400. At least one magnetic sensor 1640 may be mounted on the printed circuit board 1630. The printed circuit board 1630 may be mounted on the inner circumferential surface of the housing 1100 at the other side of the series elastic body 1400, and the printed circuit board 1630 may be positioned such that the printed circuit board 1630 and the magnetic plate 1610 face each other in a non-contact state. Consequently, the magnetic sensor 1640 may be disposed spaced apart from the magnetic plate 1610 by a predetermined distance. As the magnetic plate 1610 is rotated together with the series elastic body 1400, changes in the magnetic field may occur, and the magnetic sensor 1640 may detect these changes in the magnetic field. In this manner, the rotational displacement of the series elastic body 1400 may be detected by the magnetic sensor 1640.

According to an embodiment of the present disclosure, a series elastic actuator (SEA) may be adopted as an actuator of stabilizer assembly, whereby it is possible to eliminate a torque sensor and a decoupler from a conventional structure and to perform the functions thereof through the series elastic actuator.

Furthermore, the displacement of an elastic body may be detected by a magnetic encoder, instead of the torque sensor, whereby it is possible to perform precise roll control.

Moreover, the torque sensor and the decoupler may be replaced by a series elastic body, whereby it is possible to reduce production costs.

The above is only an embodiment for implementing a stabilizer assembly with a series elastic actuator according to the present disclosure, the present disclosure is not limited to the above embodiment, and a person having ordinary skill in the art to which the present disclosure pertains will recognize the technical spirit of the present disclosure to the extent that various modifications can be made without departing from the gist of the present disclosure as claimed in the following claims.

What is claimed is:

1. A stabilizer assembly with a series elastic actuator, the stabilizer assembly comprising:
a first stabilizer bar connected to one side wheel;
a second stabilizer bar connected to the other side wheel; and
an actuator disposed between the first and second stabilizer bars, the actuator being configured to transmit rotational force between the first and second stabilizer bars, wherein
the actuator comprises a housing and a motor, a multi-stage gear, and a series elastic body disposed in the housing.

2. The stabilizer assembly as claimed in claim 1, wherein
an end of the first stabilizer bar is fixedly installed to one end of the actuator while an end of the second stabilizer bar is rotatably installed to the other end of the actuator,
the motor and the multi-stage gear are sequentially disposed in a direction from the one end to the other end of the actuator,
the multi-stage gear comprises a first planetary gear, a second planetary gear, and a third planetary gear sequentially disposed in an axial direction toward the other end of the actuator, and
each planetary gear comprises a sun gear and a plurality of pinion gears disposed around the sun gear, the pinion gears being gear engaged with gear teeth formed on an inner circumferential surface of the housing.

3. The stabilizer assembly as claimed in claim 2, wherein
the first planetary gear is operated by driving of the motor, a driving shaft of the motor protrudes to the other side to form a sun gear of the first planetary gear, the plurality of pinion gears is rotatably or revolvably disposed about the sun gear of the first planetary gear, and a first carrier is rotatably connected to the pinion gears of the first planetary gear, and
the second planetary gear is operated by rotation of the first carrier, a carrier shaft of the first carrier protrudes to the other side to form a sun gear of the second planetary gear, a plurality of pinion gears is rotatably or revolvably disposed about the sun gear of the second planetary gear, and a second carrier is rotatably connected to the pinion gears of the second planetary gear.

4. The stabilizer assembly as claimed in claim 3, wherein the series elastic body is configured such that a plurality of elastic plates is arranged side by side in an axial direction and adjacent ones of the elastic plates are positionally constrained by a pin.

5. The stabilizer assembly as claimed in claim 3, wherein the series elastic body is a spring type series elastic body in which a coil extends in the axial direction to provide axial elasticity or a cage type series elastic body in which a plurality of rods extends in the axial direction while being spaced apart from each other along an outer circumference thereof.

6. The stabilizer assembly as claimed in claim 4 or 5, wherein the series elastic body is disposed between the second planetary gear and the third planetary gear.

7. The stabilizer assembly as claimed in claim 6, wherein
one side of the series elastic body is fixedly coupled to the second carrier to receive rotational force of the second carrier, and a driving carrier is fixedly installed on the other side of the series elastic body,
a carrier shaft of the driving carrier protrudes to the other side to form a sun gear of the third planetary gear, a plurality of pinion gears is rotatably or revolvably disposed about the sun gear of the third planetary gear, and a third carrier is rotatably connected to the pinion gears of the third planetary gear, and
the third carrier is mounted on the inner circumferential surface of the housing via a bearing member, and the end of the second stabilizer bar is coupled to the other side of the third carrier.

8. The stabilizer assembly as claimed in claim 4 or 5, wherein the series elastic body is disposed between the third planetary gear and the other end of the actuator.

9. The stabilizer assembly as claimed in claim 8, wherein
the third planetary gear is operated by rotation of the second carrier, a carrier shaft of the second carrier protrudes to the other side to form a sun gear of the third planetary gear, a plurality of pinion gears is rotatably or revolvably disposed about the sun gear of the third planetary gear, and a third carrier is rotatably connected to the pinion gears of the third planetary gear,
one side of the series elastic body is fixedly coupled to the third carrier to receive rotational force of the third carrier, and a driving carrier is fixedly installed on the other side of the series elastic body, and
the driving carrier is mounted on the inner circumferential surface of the housing via a bearing member, and the end of the second stabilizer bar is coupled to the other side of the driving carrier.

10. The stabilizer assembly as claimed in claim 1, wherein a barrier block is press-fitted and fixed between the motor and one end of the actuator, the first stabilizer bar is fixed to the barrier block, and a face spline is provided on each of facing sections of the first stabilizer bar and the barrier block such that the first stabilizer bar and the barrier block are spline coupled to each other.

11. The stabilizer assembly as claimed in claim 7, wherein a face spline is provided on each of facing sections of the third carrier and the second stabilizer bar such that the third carrier and the second stabilizer bar are spline coupled to each other.

12. The stabilizer assembly as claimed in claim 9, wherein a face spline is provided on each of facing sections of the driving carrier and the second stabilizer bar such that the driving carrier and the second stabilizer bar are spline coupled to each other.

13. The stabilizer assembly as claimed in claim 4 or 5, comprising:
a magnetic encoder, wherein
the magnetic encoder is configured such that:
a magnetic plate with alternating polarities is disposed on the outer surface of the series elastic body;
a printed circuit board having at least one magnetic sensor mounted thereon is mounted on the inner circumferential surface of the housing, and the magnetic sensor is spaced apart from the magnetic plate by a predetermined distance; and
a change in a magnetic field generated by rotation of the magnetic plate together with the series elastic body is detected by the magnetic sensor, thereby detecting rotational displacement of the series elastic body.
